(19) United States
(12) Patent Application Publication
(10) Pub. No.: US 2002/0023977 A1
(43) Pub. Date: Feb. 28, 2002

(54) Crushing device

(76) Inventor: Shoji Nakagomi, Urawa-shi (JP)

Correspondence Address: Eric B. Meyertons, CONLEY, ROSE & TAYON. P.C., P.O. Box 398, Austin, TX, 78767-0398, US

(21) Appl. No.: 09/881,383

(22) Filed: Jun. 13, 2001

(30) Foreign Application Priority Data
Jun. 15, 2000 (JP) 2000-180488

(51) Int. Cl. B02C 18/16

(52) U.S. Cl. 241/236; 241/295

(57) ABSTRACT

In a three axes type crushing device, an area where a finely fragmenting blade rotary structure receives fragments is enlarged, and a blade clearance between a stationary blade and a finely fragmenting blade is adjusted relatively easily. A roughly fragmenting unit includes a pair of roughly fragmenting blade rotary structures (1), each having a large number of roughly fragmenting blades (2) with clearances substantially corresponding to thicknesses of the roughly fragmenting blades. The roughly fragmenting blade rotary structures are supported to be rotatable inward relative to each other and to be located such that the roughly fragmenting blades of one roughly fragmenting blade rotary structure enter the clearances between the roughly fragmenting blades of the other roughly fragmenting blade rotary structure, and the material nipped by the roughly fragmenting blades is cut by blade portions of opposing roughly fragmenting blades to be roughly fragmented into fragments, which falls downward. A finely fragmenting unit disposed below the roughly fragmenting unit includes a finely fragmenting blade rotary structure (9) having a large number of finely fragmenting blades (92) which finely fragments the fragments in cooperation with a stationary blade (10). The finely fragmenting blade rotary structure is disposed at such a position that makes a center normal line thereof (L1) offset in a lateral direction relative to a center normal line (L2) of a cutting portion constructed by the roughly fragmenting blades of the roughly fragmenting blade rotary structures. The stationary blade is disposed in the offset direction, and the finely fragmenting blade rotary structure is rotated in a direction toward the stationary blade.

### BACKGROUND OF THE INVENTION

1. Field of the Invention

The present invention relates to a crushing device for roughly fragmenting and finely fragmenting a scrap material, such as a synthetic resin product.

2. Description of the Related Art

A crushing device used for recycling scrap materials, such as synthetic resin products, may perform rough and fine fragmentation with a single unit configured as shown in FIG. 9, with a pair of roughly fragmenting blade rotary structures A and A′, a finely fragmenting blade rotary structure B, and a stationary blade C functioning in cooperation with structure B, all of which may be installed inside the device.

Roughly fragmenting blade rotary structure A may be generally constructed with a substantially large number of roughly fragmenting blades a mounted to a shaft portion with a clearance between the blades corresponding to a thickness of a blade and in a state where the phases may be shifted. Roughly fragmenting blade rotary structures A and A′ may be supported at a position such that roughly fragmenting blades a of roughly fragmenting blade rotary structure A may be inserted into the clearance between adjacent roughly fragmenting blades a′ of roughly fragmenting blade rotary structure A′. Structures A and A′ may receive a drive force to rotate inward relative to each other. Roughly fragmenting blades a and a′ may have a plurality of protruded blades a1 and a1′, respectively, in the form of a claw, which may be protrudingly arranged on an outer peripheral surface with intervals in the circumferential direction. A blade portion may be formed on an outer peripheral edge portion including protruded blades a1 and a1′ and the outer peripheral surface. The blade portions of roughly fragmenting blades a′ of roughly fragmenting blade rotary structure A′ may be inserted into the clearances between roughly fragmenting blades a of roughly fragmenting blade rotary structure A so that the blade portions of both roughly fragmenting blades a and a′ cut the scrap material of the synthetic resin product into fragments the width of which may be substantially the same as the clearance portion. The fragments thus cut may substantially fall downward.

On the other hand, finely fragmenting blade rotary structure B may be disposed below roughly fragmenting blade rotary structures A and A′ to receive the fragments and finely fragment the fragments in cooperation with stationary blade C, which may be fixed to a casing or a device main body inner wall. In general, finely fragmenting blade rotary structure B may be constructed such that a substantially large number of annular finely fragmenting blades, each having a substantially large number of finely fragmenting blades b arranged around a cylindrical barrel portion, may be formed on the barrel portion with clearances substantially in the axial direction. Stationary blade C may be engaged with the annular finely fragmenting blades to substantially crush the fragments finely.

Finely fragmenting blade rotary structure B may be disposed such that a central normal line L1 may be substantially coincident with a central normal line L2 of the cutting portion of the roughly fragmenting blade rotary structures A and A′ located substantially above structure B. Consequently, a distance between a position at which a fragment may be received and a position at which the fragment reaches the crushing portion where stationary blade C may be located may be substantially short, and an area d, as illustrated in FIG. 9, for receiving the fragment may be substantially small.

The particle size of the crushed material after the fragment is finely fragmented may be determined by a dimension of the clearance between the blade portion of stationary blade C and the blade portion of the finely fragmenting blades of finely fragmenting blade rotary structure B. However, as shown in FIG. 9, the crushing portion constructed by stationary blade C and the finely fragmenting blades of finely fragmenting blade structure B may be located substantially close to a center of the device, such that an adjustment thereof may be considerable troublesome.

### SUMMARY OF THE INVENTION

An embodiment may provide a three axes type crushing device, which may enlarge an area where a finely fragmenting blade rotary structure may receive fragments, and which it may be relatively easy to adjust a clearance between a stationary blade and the finely fragmenting blade.

An embodiment may be directed to a substantially improved crushing device in which roughly fragmenting means may be disposed in an upper space within a device main body casing, and finely fragmenting means may be disposed in a lower space within the device main body casing, so that a material to be processed may be roughly fragmented by the roughly fragmenting means and then finely fragmented by the finely fragmenting means.

In an embodiment, the roughly fragmenting means may include a pair of roughly fragmenting blade rotary structures, each having a substantially large number of roughly fragmenting blades with clearances substantially corresponding to a thickness of the roughly fragmenting blades. The roughly fragmenting blade rotary structures may be supported to be rotatable substantially inward relative to each other and may be located such that the roughly fragmenting blades of one roughly fragmenting blade rotary structure enter the clearances between the roughly fragmenting blades of the other roughly fragmenting blade rotary structure. As such, the material may be cut by blade portions of opposing roughly fragmenting blades and roughly fragmented into fragments which may substantially fall downward.

In a further embodiment, the finely fragmenting means may include a finely fragmenting blade rotary structure having a substantially large number of finely fragmenting blades which may finely fragment the fragments in cooperation with a stationary blade. The finely fragmenting blade rotary structure may be disposed such that a position that makes a center normal line thereof may be offset in a substantially lateral direction relative to a center normal line of a cutting portion constructed by the roughly fragmenting blades of the roughly fragmenting blade rotary structures. The stationary blade may be correspondingly disposed in the offset direction, and the finely fragmenting blade rotary structure may be rotated in a direction substantially toward the stationary blade.

Furthermore, the stationary blade may be fixed to a rotatable door of the device main body casing, and distal end blades of the stationary blade may be engaged with the finely fragmenting blades of the finely fragmenting blade rotary structure when the rotatable door is substantially closed. In this manner, adjustment of a clearance between the stationary blade and the finely fragmenting blades may be conducted more efficiently.

In a preferred embodiment, the finely fragmenting blades of the finely fragmenting blade rotary structure and the engaging blade portions of the stationary blade may both be substantially trapezoidal in a plane view.

It may also be preferable that the roughly fragmenting blade be formed with a recessed portion in a substantially annular manner, which may be located in a side surface of a roughly fragmenting blade main body having an outer peripheral edge formed with a blade portion. Further, the recessed portion may be formed in an intermediate region that may be on an inner side of the roughly fragmenting blade body in a substantially radial direction with respect to the blade portion, and substantially outside a bearing region. As such, the recessed portion may facilitate the removal of cut fragments, thus making it possible to efficiently perform rough fragmentation with roughly fragmenting blade rotary structures, and substantially improve a crushing process efficiency in conjunction with fine fragmentation by the finely fragmenting blade rotary structure.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 depicts a side sectional view of an embodiment of a crushing device;

FIG. 2 depicts a side view of the crushing device of FIG. 1;

FIG. 3 depicts a frontal view of the crushing device of FIG. 1;

FIG. 4 depicts a side view of an embodiment of a roughly fragmenting blade used in the crushing device of FIG. 1;

FIG. 5 depicts a frontal sectional view of the roughly fragmenting blade of FIG. 4;

FIG. 6 depicts a plane view of a meshing engagement state of the roughly fragmenting blades of the roughly fragmenting blade rotary structures of FIG. 1;

FIG. 7 depicts a plane view of an embodiment of a finely fragmenting blade rotary structure and a stationary blade of FIG. 1;

FIG. 8 depicts a side view of the finely fragmenting blade rotary structure of FIG. 7; and

FIG. 9 depicts a side sectional view of a conventional crushing device.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

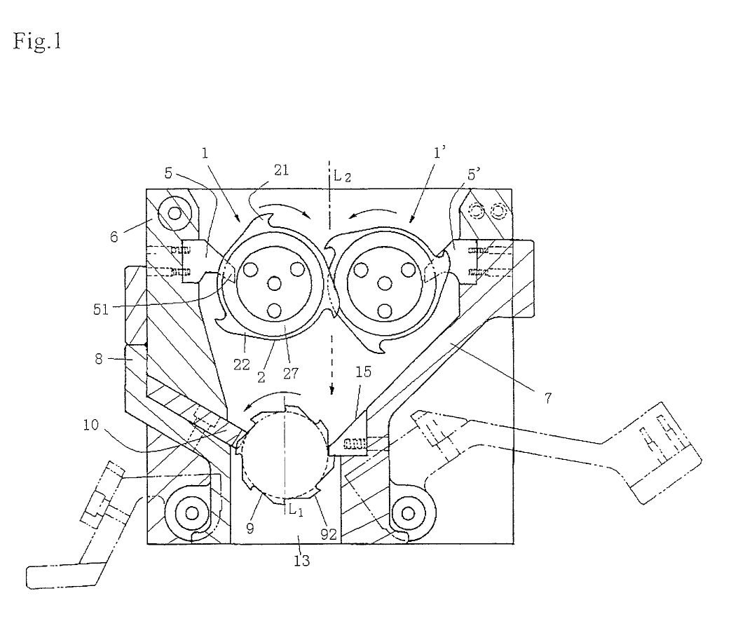

Referencing FIG. 1, 1 and 1′ denote a pair of roughly fragmenting blade rotary structures which may be rotatably supported in an upper space within a crushing device main body casing. Roughly fragmenting blade rotary structures 1 and 1′ may have the same construction. As such, roughly fragmenting blade rotary structure 1 will be described herein such that the description may substantially apply correspondingly to rougly fragmenting blade rotary structure 1′. Corresponding components of roughly fragmenting blade rotary structure 1′ will be denoted in the drawings or in the following description by references with a dash (′).

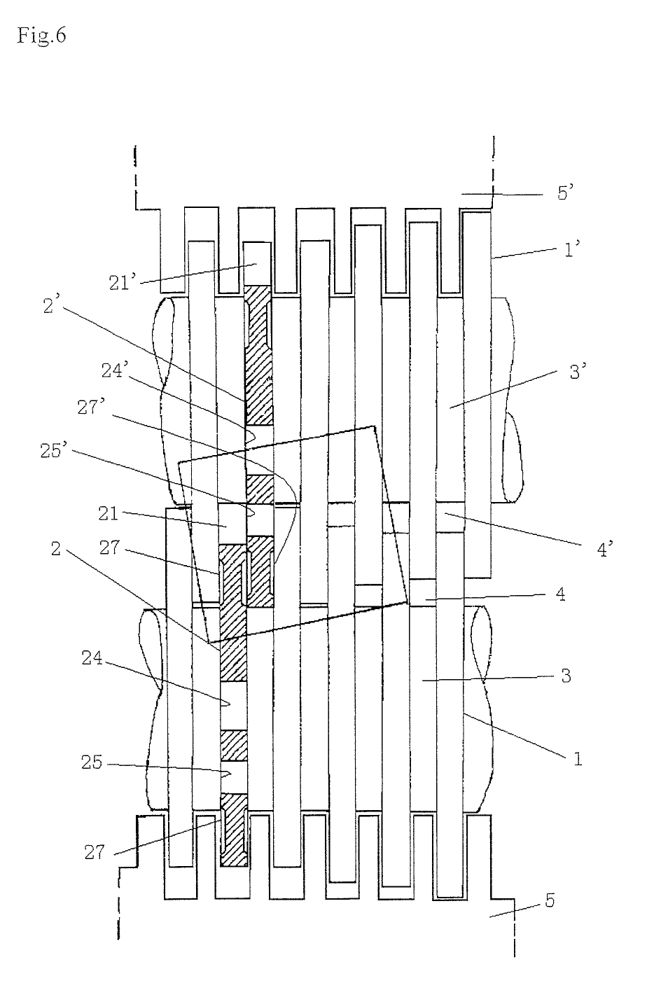

Roughly fragmenting blade rotary structure 1 may include a substantially large number of roughly fragmenting blades 2, annular connection members 3, as shown in FIG. 6, for connecting roughly fragmenting blades 2 with predetermined clearances, and a connection bolt (not shown) piercing through roughly fragmenting blades 2 and annular connection members 3 to connect and fix these members together.

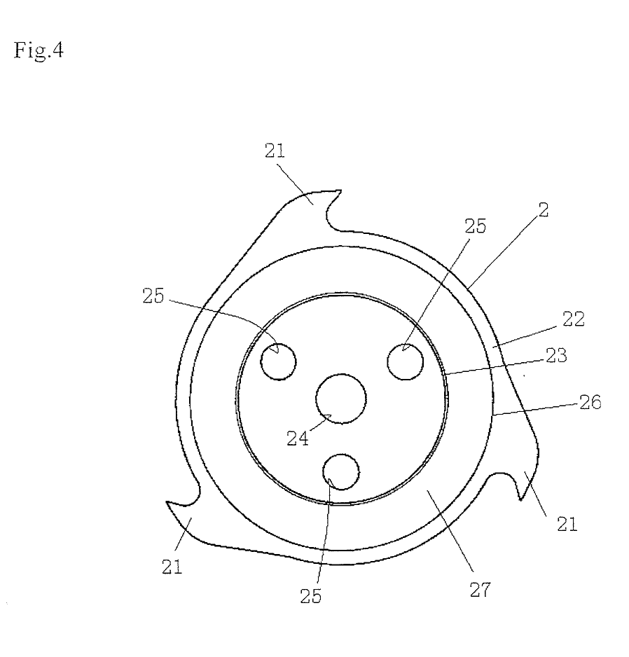

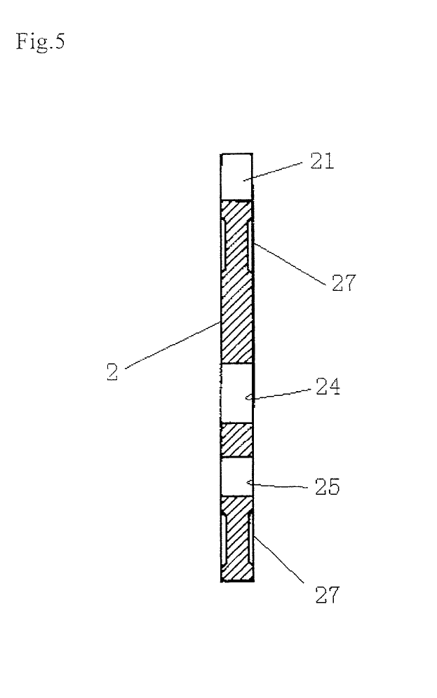

In an embodiment, as illustrated in FIGS. 4 and 5, each of roughly fragmenting blades 2 may be provided with three protruded blades 21 in the form of claws, which may be protrudingly arranged on an outer peripheral surface with circumferential intervals of approximately 120 degrees. A blade portion 22 may be formed on an outer peripheral edge portion including protruded blades 21 and the remaining outer peripheral surface. A substantially large number of roughly fragmenting blades 2 may be mounted such that the phases of protruded blades 21 are substantially shifted.

Roughly fragmenting blades 2 may be further configured with a bearing portion region 23 provided in a side surface and may be formed at its center with an insertion hole 24 for the connection bolt and, at substantially concentric positions apart from the center by a predetermined distance, three pin holes 25. An end face of annular connection members 3 interposed between adjacent roughly fragmenting blades may be brought into contact with and fixed to bearing portion region 23. Annular connection members 3 may be substantially smaller in diameter than roughly fragmenting blade 2 and may have a width substantially the same as a thickness width of roughly fragmenting blade 2. Similar to roughly fragmenting blades 2, annular connection members 3 may have an insertion hole for the connection bolt at its center, and three pin holes around the insertion hole. By inserting pins and the connection bolts into the pin holes and the insertion holes, respectively, and tightening a bolt end portion with a nut, roughly fragmenting blades 2 and annular connection members 3 may be united to construct roughly fragmenting blade rotary structure 1. As such, an outer portion of the peripheral surface of annular connection members 3, which may be partitioned by adjacent roughly fragmenting blades 2, substantially forms a clearance portion 4 into which a roughly fragmenting blade 2 of roughly fragmenting blade rotary structure 1′ may be inserted, as shown in FIG. 6.

An intermediate portion region 26 defined substantially between bearing portion region 23 of the roughly fragmenting blade side surface and blade portion 22 may be formed with an annular recessed portion 27. The recessed portion 27 may extend from a boundary between intermediate portion region 26 and bearing portion region 23 to a boundary between intermediate portion region 26 and blade portion region 22, and may occupy substantially the entire intermediate portion region 26. Recessed portion 27 may be provided in each side surface of roughly fragmenting blade 2, and may have an appropriate depth that does not adversely affect the strength of roughly fragmenting blade 2.

In a further embodiment, roughly fragmenting blade rotary structures 1 and 1′ may be rotatably supported such that rotational axes thereof may be substantially parallel to each other, and projected blades 21 of roughly fragmenting blades 2 may be substantially symmetrical. Roughly fragmenting blade rotary structures 1 and 1′ may be further configured to rotate inward relatively to each other while blade portion 22, including protruded blades 21 of the roughly fragmenting blade 2 of the roughly fragmenting blade rotary structure 1, enters a clearance portion 4′ between the roughly fragmenting blades of roughly fragmenting blade rotary structure 1′. In this manner, the blade portions of the roughly fragmenting blades may be slidingly contacted, as shown in FIG. 6.

In another embodiment, scrapers 5 and 5′ in FIGS. 1 and 6 may be disposed external to roughly fragmenting blade rotary structures 1 and 1′, respectively, and may be positioned such that a leading end scraping claw 51 enters the clearance between the roughly fragmenting blades of the roughly fragmenting blade rotary structures. As such, for example, during rotation of roughly fragmenting blade rotary structure 1, the scraper substantially scrapes fragments remaining in the clearance. Scraper 5 may be fixed to an upper portion of a left upper rotatable door 6 having its upper portion hinge-connected to the device main body casing. Scraper 5′ may be fixed to an upper portion of a right rotatable door 7 having its lower portion hinge-connected to the casing. The open position of right rotatable door 7 may be shown by dotted line in FIG. 1. Provided below left upper rotatable door 6 may be lower rotatable door 8 having its lower portion hinge-connected to the casing.

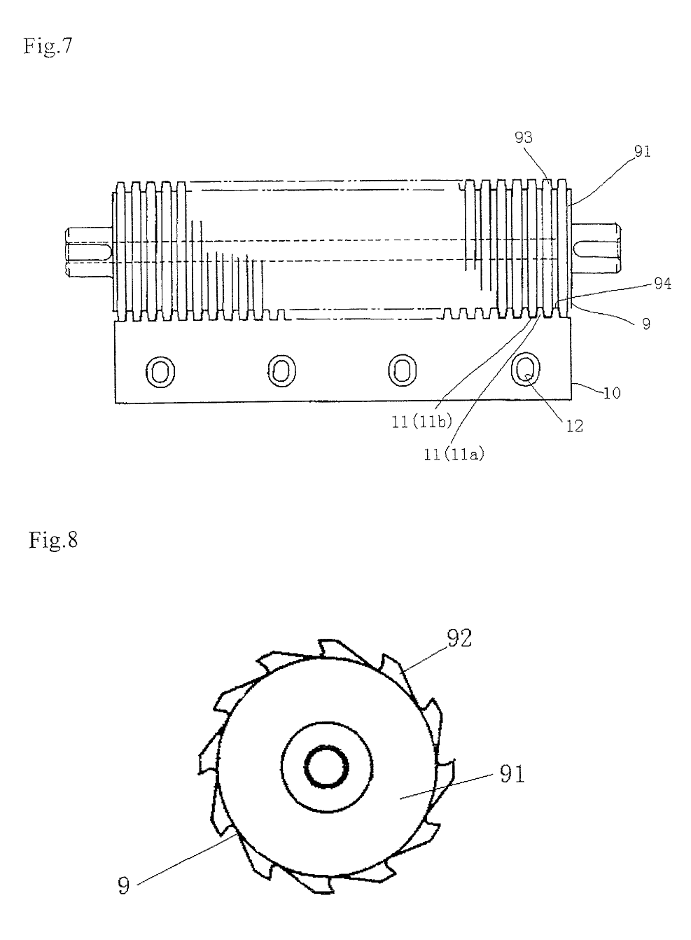

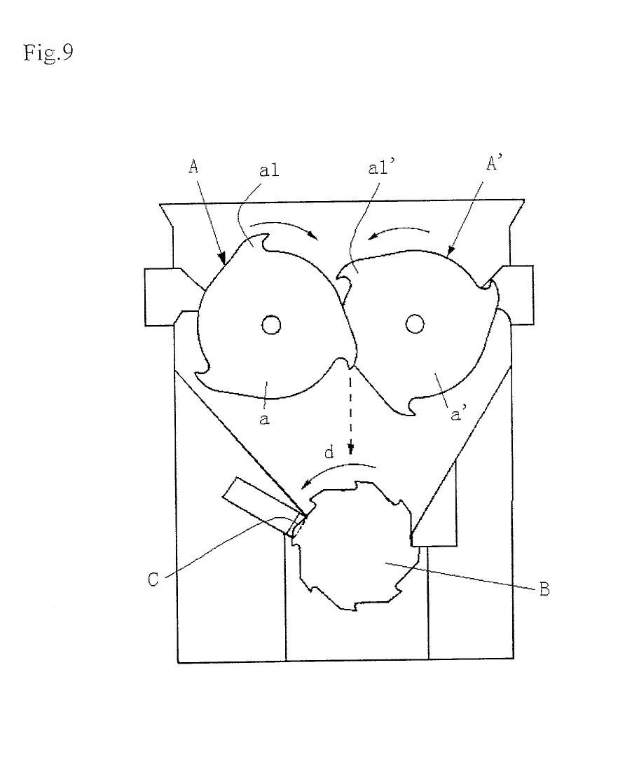

Another embodiment may include a single finely fragmenting blade rotary structure 9 rotatably supported in a space substantially below the pair of roughly fragmenting blade rotary structures 1 and 1′. As shown in FIGS. 7 and 8, finely fragmenting blade rotary structure 9 may be configured such that a substantially large number of finely fragmenting blades 92 may be protruded substantially around a surface of a cylindrical barrel portion 91. Annular protruded blades 93 may be juxtaposed with predetermined clearances. As shown in FIG. 7, a blade tip of finely fragmenting blade 92 may be substantially in the form of a trapezoid in a plane view. Finely fragmenting blade rotary structure 9 may be supported at a position such that a central normal line L₁ is substantially offset from a central normal line L₂ at a position where the blade portions 22 of roughly fragmenting blade rotary structures 1 and 1′ are substantially engaged during rough fragmentation, as shown in FIG. 1.

In addition, finely fragmenting blade rotary structure 9 may be positioned, substantially close to left lower rotatable door 8. A stationary blade 10 may be attached to a lower portion of the left lower rotatable door 8. Stationary blade 10 may be configured with a substantially comb-like plurality of concave and convex blades 11 formed from a plate material and substantially arranged at a leading end of a stationary blade main body, as shown in FIG. 7. Convex blades 11a may be substantially in the form of a trapezoid in a plane view similar to finely fragmenting blade 92, and may enter a clearance 94 between finely fragmenting blades 92 of finely fragmenting blade rotary structure 9. Conversely, finely fragmenting blade 92 may enter between convex blades 11a so as to be substantially adjacent with concave blades 11b.

In addition, an oblong hole 12 may be formed in the stationary blade main body for fastening a bolt. Oblong hole 12 may be configured such that changing a position at which the bolt may be fastened within a range of the length of oblong hole 12, the clearance between finely fragmenting blade 92 of finely fragmenting blade rotary structure 9 and concave and convex blades 11 of stationary blade 10 may be adjusted.

In a further embodiment, finely fragmenting blade rotary structure 9 may be rotated in a direction toward stationary blade 10.

Additionally, finely fragmenting blade rotary structure 9 may be positioned substantially adjacent to right rotatable door 7. A scraper 15, as shown in FIG. 1, may be attached to an inner wall surface of right rotatable door 7. As such, scraper 15 may substantially scrape small pieces of crushed material, which may be remaining in clearances 94 between finely fragmenting blades 92, by inserting leading end comb-like scraping claws into clearances 94.

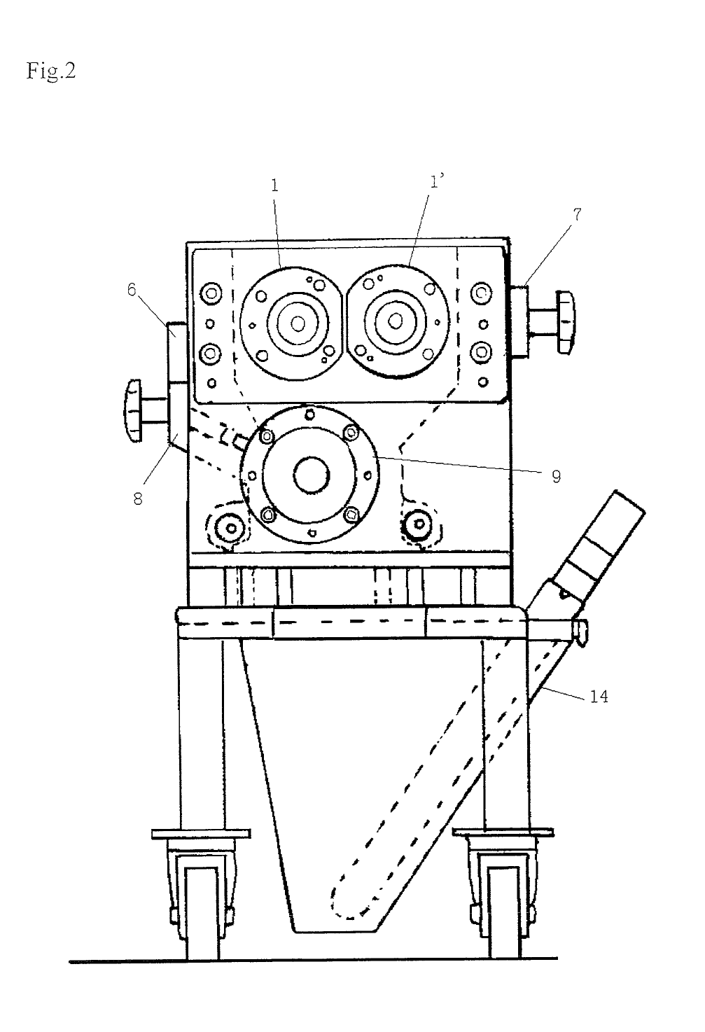

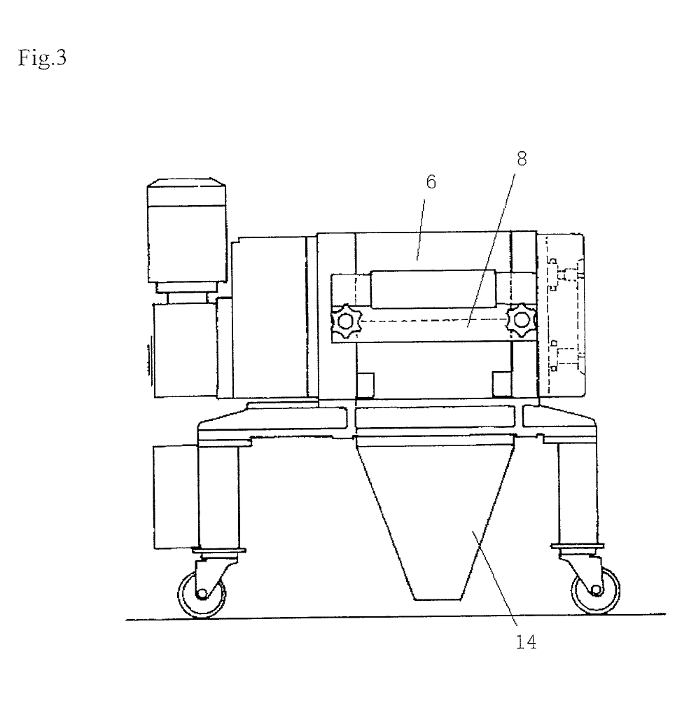

A further embodiment of the crushing device may include a discharge port 13, as shown in FIG. 1, provided substantially below finely fragmenting blade rotary structure 9. In addition, as shown in FIGS. 2 and 3, a container 14 for crushed material may be disposed substantially below discharge port 13.

Operation of the crushing device may include placing a scrap material into the device through an appropriate means, such as a throw-in port disposed at an upper portion of the device illustrated in FIGS. 1 to 3, such that the material falls onto the upper surfaces of roughly fragmenting blade rotary structures 1 and 1′. As such, roughly fragmenting blade rotary structures 1 and 1′ may substantially move the scrap material in a direction toward the central normal line L₂ of the cutting portion of roughly fragmenting blade rotary structures 1 and 1′. In this manner, roughly fragmenting blade rotary structures 1 and 1′ may substantially cut the scrap material into fragments with blade portions 22 of roughly fragmenting blades 2 while substantially pulling the scrap material inside with protruded blades 21. As such, the fragments may be in the form of a strip having a width thickness approximately that of roughly fragmenting blade 2. During cutting, the fragment may be slightly deformed, and after cutting, the ends of the fragment may be elastically restored within clearance portion 4 and 4′ into which protruded blades 21′ and 21 enter, respectively, and become substantially enlarged beyond the dimension of the clearance between blade portions 22. A roughly fragmenting blade 2 may be configured with recessed portion 27 in intermediate portion region 26 with respect to blade portion 22, such that clearance 4 between roughly fragmenting blades 2 may be substantially wider by an amount corresponding to approximately the sum of depths of adjacent recessed portions 27, as illustrated in FIG. 6. In this manner, the enlargement of the fragment may be cancelled out by recessed portions 27 and, as such, may fall through clearance 4, and not substantially accumulate below scrapers 5 and 5′. As such, roughly fragmenting blade rotary structures 1 and 1′ may then substantially maintain an initial operating rotation speed and an initial torque.

Recessed portion 27, which may be formed in each side surface of roughly fragmenting blade 2, may be a continuous annulus or a plurality of recessed portions arranged intermittently in a substantially annular manner. An embodiment may include recessed portion 27 formed only in one side surface of the roughly fragmenting blade 2. In this case, roughly fragmenting blades 2 may be assembled such that recessed portion 27 may be substantially disposed at either one of the opposing side surfaces of adjacent roughly fragmenting blades.

In an embodiment previously described, fragments that may have fallen under roughly fragmenting blade rotary structures 1 and 1′ may be received by the upper surface of finely fragmenting blade rotary structure 9. Central normal line L₁ of finely fragmenting blade rotary structure 9 may be offset in a direction toward stationary blade 10 relative to central normal line L₂ such that the fragments may be received by an upper surface position of finely fragmenting blade rotary structure 9, which may be offset in a rightward direction from central normal line L₁. As such, a substantially large area may be used as a receiving space, extending from the upper surface position to a position where finely fragmenting blade rotary structure 9 performs the fine fragmentation in cooperation with stationary blade 10.

Fragments moved to the crushing portion of finely fragmenting blade rotary structure 9 and stationary blade 10 by rotation of annular protruded blades 93 may then be finely fragmented or substantially crushed by trapezoidal concave and convex blades 11 of stationary blade 10 and finely fragmenting blades 92 of finely fragmenting blade rotary structure 9. The fine fragments may then fall down from discharge port 13 to be accommodated within container 14.

The degree of crushing may be determined by positioning stationary blade 10 forward or backward along oblong holes 12 in order to adjust the clearance between concave and convex blades 11 and finely fragmenting blades 92. The required work for this clearance adjustment, such as confirmation using a clearance gage, and tightening of a fixing piece with bolts, may be conducted relatively easily since central normal line L₁ of finely fragmenting blade rotary structure 9 may be offset from central normal line L₂ of the cutting portion of roughly fragmenting blade rotary structures 1 and 1′, and stationary blade 10 may be located at a position close to the near side of an operator with respect to the central portion of the device main body.

Since concave and convex blades 11 and finely fragmenting blades 92 may each be in a substantially trapezoidal shape in a plane view, a proximal end may have an obtuse angle and, further, a distal end may be wider than the proximal end. As such, stationary blade 10 may be hardly chipped and substantially easy to handle in a case where the blade may be worn out, in contrast to a conventional blade having a substantially rectangular shape in a plane view. Also, clearance adjustments may be conducted relatively easily.

In an embodiment described herein, roughly fragmenting blade structures 1 and 1′ may cut the scrap material into fragments by slidingly contacting blade portions 22 of opposing roughly fragmenting blades 2 with one another. Therefore, the fragments may be inevitably formed as strips having a width substantially corresponding to the widths of roughly fragmenting blades 2 and may be relatively large pieces. However, the final crushed material may require a particle quality substantially comparable to virgin pellets in order to be placed into, for example, a synthetic resin molding machine. For this reason, the device of the embodiment described above may be provided with finely fragmenting blade rotary structure 9 disposed substantially below roughly fragmenting blade rotary structures 1 and 1′ for finely fragmenting the fragments. In order to make sure that the finely fragmented fragments have a particle quality substantially close to that of the virgin pellets, the fragments obtained by the anterior roughly fragmenting process should not be substantially large. For example, the width of roughly fragmenting blade 2 may be preferably set to be no greater than approximately 1.7 times an apex-to-bottom dimension of finely fragmenting blade 92, taking into account a processing efficiency.

In a further embodiment described herein, when maintenance is required, right rotatable door 7 may be opened downward such that the rear portion of roughly fragmenting blade rotary structure 1′, scraper 5′, and scraper 15 may be exposed. Left lower rotatable door 8 may be opened downward such that the front portion of finely fragmenting blade rotary structure 9 and stationary blade 10 may be exposed. left upper rotatable door 6 may also be opened upward such that roughly fragmenting blade rotary structure 1 and scraper 5 may be exposed. Right rotatable door 7 and left upper rotatable door 6 may be opened smoothly in the absence of a substantial accumulation of fragments below the scrapers. In this manner, cleaning and replacement of parts, and checking device operation may be conducted relatively easily.

The crushing device using the roughly fragmenting blades according to the embodiments described herein may not be limited to scrap material of a synthetic resin product, and may be applied as devices for crushing various other materials in which the roughly fragmenting blade rotary structures may be provided in its upper part and the finely fragmenting blade rotary structure may be arranged in its lower part.

Although the central normal line of the finely fragmenting blade rotary structure may be offset in a leftward direction as in FIG. 1, conversely, it may be offset in a rightward direction. The degree of offset may be set depending on the size of the device, the distance from the roughly fragmenting blade rotary structures, etc. In a case of offset in the rightward direction, the stationary blade may be similarly fixed to a device inner wall surface on the right hand side, and the finely fragmenting blade rotary structure may be rotated in a clockwise direction.

Finally, the center normal line of the finely fragmenting blade rotary structure may be offset in a lateral direction relative to the central normal line of the cutting portion composed of the roughly fragmenting blades of the roughly fragmenting blade rotary structures, and the stationary blade may be disposed in substantially the same direction. The finely fragmenting blade rotary structure may be rotated in the direction toward the stationary blade. Consequently, the area where the finely fragmenting blade rotary structure may receive the fragments roughly fragmented by the roughly fragmenting blade rotary structures may be set to be substantially large. Further, the crushing portion composed of the stationary blade and the finely fragmenting blades may be located substantially close to the front side or a rear side of the device main body casing, such that adjustment work of the blade portion clearance may be performed relatively easily.

Further modification and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed:

1. A crushing device in which roughly fragmenting means is disposed in an upper space within a device main body casing, and finely fragmenting means is disposed in a lower space within the device main body casing, so that a material to be processed is roughly fragmented by the roughly fragmenting means and then finely fragmented by the finely fragmenting means, wherein:
the roughly fragmenting means includes a pair of roughly fragmenting blade rotary structures, each having a plurality of roughly fragmenting blades with clearances substantially corresponding to a thickness of the roughly fragmenting blades;
the roughly fragmenting blade rotary structures are supported to be rotatable inward relative to each other and to be located such that the roughly fragmenting blades of one roughly fragmenting blade rotary structure enter the clearances between the roughly fragmenting blades of the other roughly fragmenting blade rotary structure, and wherein the material is cut by blade portions of opposing roughly fragmenting blades to be roughly fragmented into fragments;
the finely fragmenting means includes a finely fragmenting blade rotary structure having a plurality of finely fragmenting blades which finely fragments the fragments in cooperation with a stationary blade;
the finely fragmenting blade rotary structure is disposed at such a position that makes a center normal line thereof offset in a lateral direction relative to a center normal line of a cutting portion constructed by the roughly fragmenting blades of the roughly fragmenting blade rotary structures; and
the stationary blade is disposed in the offset direction, and the finely fragmenting blade rotary structure is rotated in a direction toward the stationary blade.

2. The crushing device according to claim 1, wherein:
the stationary blade is fixed to a rotatable door of the device main body casing; and
distal end blades of the stationary blade are engaged with the finely fragmenting blades of the finely fragmenting blade rotary structure when the rotatable door is closed.

3. The crushing device according to claim 1, wherein:
the roughly fragmenting blade is formed with a recessed portion in an annular manner, which is located in a side surface of a roughly fragmenting blade main body having an outer peripheral edge formed with a blade portion and in an intermediate region that is on the inner side in the radial direction with respect to the blade portion and is outside a bearing region, for facilitating removal of cut fragments.

4. The crushing device according to claim 1, wherein the finely fragmenting blades of the finely fragmenting blade rotary structure and engaging blade portions of the stationary blade are both substantially trapezoidal in a plane view.

5. The crushing device according to claim 1, wherein the material to be processed is a scrap material of a synthetic resin product.

6. The crushing device according to claim 1, wherein the roughly fragmenting blades of the roughly fragmenting blade rotary structures comprises a plurality of protruded blades on an outer peripheral surface, wherein the outer peripheral surface edge is formed with a blade portion.

7. The crushing device according to claim 1, wherein the roughly fragmenting blades of the roughly fragmenting blade rotary structures comprises a bearing region on a side surface of the roughly fragmenting blade main body, wherein the bearing region comprises an insertion hole for a connection bolt substantially near the center, and further comprises a number of pin holes located in concentric positions apart from the center.

8. The crushing device according to claim 1, wherein annular connection members are located between roughly fragmenting blades of a roughly fragmenting blade rotary structure, wherein the annular connection members comprises an insertion hole for a connection bolt substantially near the center, and further comprises a number of pin holes located in concentric positions apart from the center, such that the annual connection members may be fixed to the bearing portion of the roughly fragmenting blade.

9. The crushing device according to claim 1, wherein a scraper corresponding to each roughly fragmenting blade rotary structure enters the clearances between the roughly fragmenting blades of the roughly fragmenting blade rotary structures.

10. The crushing device according to claim 1, wherein a scraper enters the clearances between finely fragmenting blades of the finely fragmenting blade rotary structure.

11. The crushing device according to claim 3, wherein the recessed portion is formed in more than one side surface of the roughly fragmenting blade main body.

12. The crushing device according to claim 3, wherein the recessed portion comprises substantially the entire intermediate region.

13. The crushing device according to claim 3, wherein the recessed portion is a continuous annulus.

14. The crushing device according to claim 3, wherein the recessed portion is a group of recesses arranged along a circumferential direction, such that the recesses together form an annulus.

15. The crushing device according to claim 3, wherein the depth of the recessed portion may be determined by a strength of the roughly fragmenting blade material.

16. The crushing device according to claim 3, wherein a single recessed portion may be positioned such that the recessed portion faces an opposing side surface of an adjacent fragmenting blade on the roughly fragmenting blade rotary structure.

17. The crushing device according to claim 6, wherein 3 protruded blades are symmetrically located in the form of a claw around the peripheral surface at approximately 120° apart.

18. The crushing device according to claim 8, wherein opposing blades of an opposing roughly fragmenting blade rotary structure may be inserted into a clearance formed by the annular connection members between roughly fragmenting blades.

19. The crushing device according to claim 8, wherein a width of the annular connection members is substantially the same as the width of the roughly fragmenting blade.

20. The crushing device according to claim 8, wherein a diameter of the annular connection members is substantially smaller than a diameter of the roughly fragmenting blade.
